(19) United States
(12) Patent Application Publication
(10) Pub. No.: US 2011/0036475 A1
(43) Pub. Date: Feb. 17, 2011

(54) PNEUMATIC TIRE

(75) Inventors: Hiroyuki KOJIMA, Minato-ku (JP); Hiroshi TOKIZAKI, Minato-ku (JP)

Correspondence Address: HAMRE, SCHUMANN, MUELLER & LARSON, P.C., P.O. BOX 2902, MINNEAPOLIS, MN, 55402-0902, US

(73) Assignee: THE YOKOHAMA RUBBER CO., LTD., Tokyo (JP)

(21) Appl. No.: 12/910,472

(22) Filed: Oct. 22, 2010

(30) Foreign Application Priority Data
Apr. 30, 2009 (JP) 2009-110427

(51) Int. Cl. B60C 3/04

(52) U.S. Cl. 152/454

(57) ABSTRACT

A pneumatic tire includes: an outer diameter and a total width being set to fall within ranges from 0 mm to 6 mm with respect to lower limits of standard dimensions in a state where the pneumatic tire is fitted to a standard rim and a normal internal pressure is applied; a tread ground contact width at 60% load being set to fall within a range from 60% to 75% of the total width; and a plurality of recesses being provided over a tire circumferential direction and a tire radial direction in a region defined on a tire outer surface excluding an area extending from an inner side end portion of the pneumatic tire to a position within 35% height of a tire cross-section height.

### BACKGROUND

1. Field

The present invention relates to a pneumatic tire to be used for, for example, passenger cars, trucks, and buses.

2. Description of the Related Art

In recent years, in conjunction with the higher performance of automobiles, various performance has also been required of tires, and on the other hand, in order to realize resource saving and reduce the amount of exhaust, development of a tire with excellent fuel efficiency has been demanded. In order to increase fuel efficiency, reduction in the rolling resistance of a tire is important, however, the rolling resistance depends on the material and rigidity, etc., of rubber, so that there is a limitation to improving the rolling resistance. As shown in FIG. 10, when the speed of a vehicle (rotation speed of tire) increases, the rolling resistance also increases, and additionally, the air resistance of a tire also increases and this leads to a deterioration in fuel efficiency.

Therefore, there is known a tire in which, in order to reduce air resistance, on the buttress portion from the tread end portion to the side wall portion, a turbulence preventing region having no irregularities such as grooves, patterns, and characters is provided to prevent turbulence at the buttress portion, and accordingly, air resistance on the tire surface is reduced. An example of such configuration is disclosed in JP-A-2003-127615.

However, when a measure is taken for preventing turbulence from occurring at the buttress portion, the air flow around a tire becomes a laminar flow, so that the rear of a tire when a vehicle travels becomes low in pressure, and a force that pulls back the tire rearward acts. Therefore, even if air resistance on a tire surface is reduced, a low-pressure portion is brought about at the rear of a tire, so that an air resistance reducing effect when traveling at a high speed cannot be sufficiently obtained.

### SUMMARY

One of objects of the present invention is to provide a pneumatic tire which is capable of effectively reducing air resistance when traveling at a high speed.

According to an aspect of the invention, there is provided a pneumatic tire including: an outer diameter and a total width being set to fall within ranges from 0 mm to 6 mm with respect to lower limits of standard dimensions in a state where the pneumatic tire is fitted to a standard rim and a normal internal pressure is applied; a tread ground contact width at 60% load being set to fall within a range from 60% to 75% of the total width; and a plurality of recesses being provided over a tire circumferential direction and a tire radial direction in a region defined on a tire outer surface excluding an area extending from an inner side end portion of the pneumatic tire to a position within 35% height of a tire cross-section height.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a partial front sectional view of a pneumatic tire showing a first embodiment of the present invention.

FIG. 2 is a partial front sectional view of the pneumatic tire showing a ground contact state.

FIG. 3 is a front sectional view of the pneumatic tire.

FIG. 4 is a partial side view of the pneumatic tire.

FIG. 5 is a partial side view of a pneumatic tire showing a second embodiment of the present invention.

FIG. 6 is a partial front sectional view of a pneumatic tire showing a third embodiment of the present invention.

FIGS. 7A and 7B are side sectional views showing exemplary variations of a recess.

FIGS. 8A and 8B are schematic views showing an air flow around the tire.

FIG. 9 is a table showing test results.

FIG. 10 is a graph showing the correlation between the speed and rolling resistance, and air resistance.

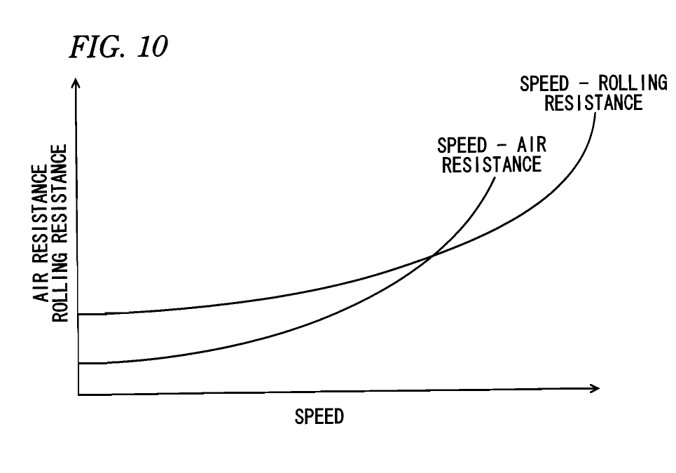

### DETAILED DESCRIPTION OF THE EMBODIMENTS

Embodiments according to the present invention will be described in detail with reference to the accompanying drawings. The scope of the claimed invention should not be limited to the examples illustrated in the drawings and those described in below.

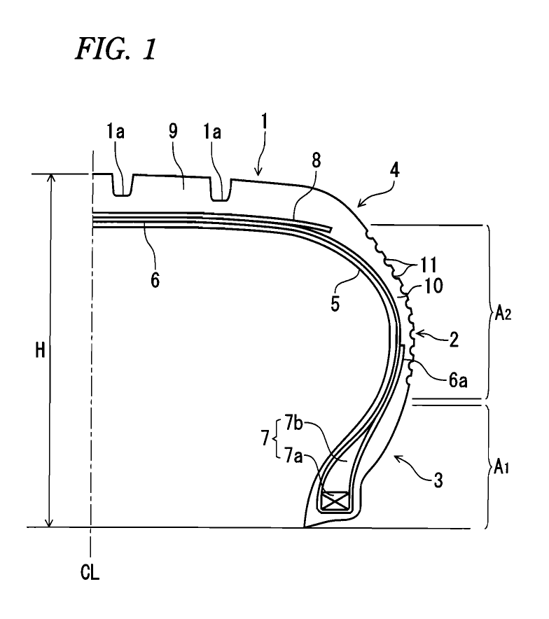

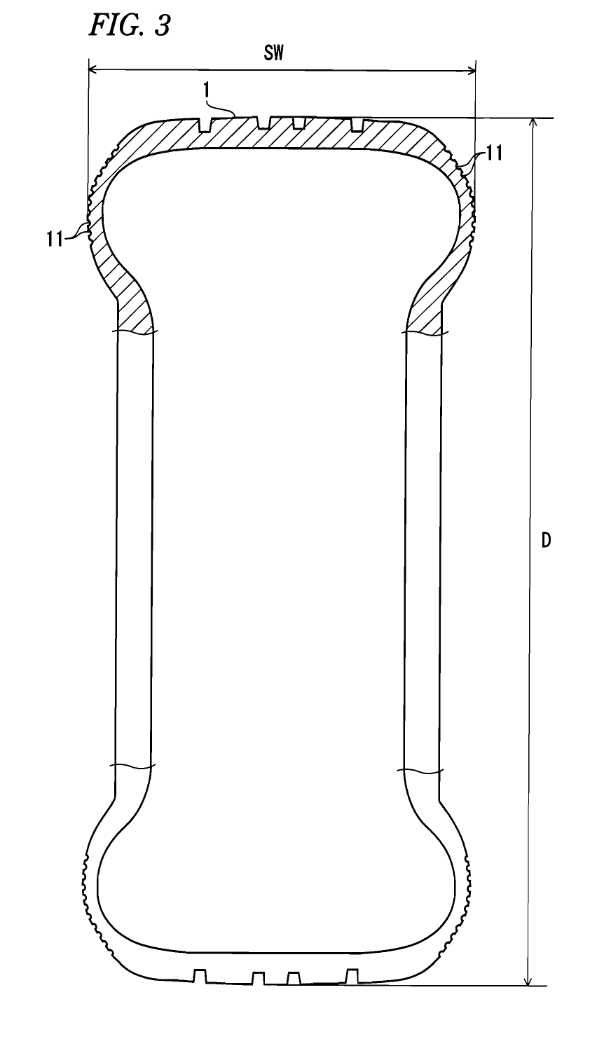

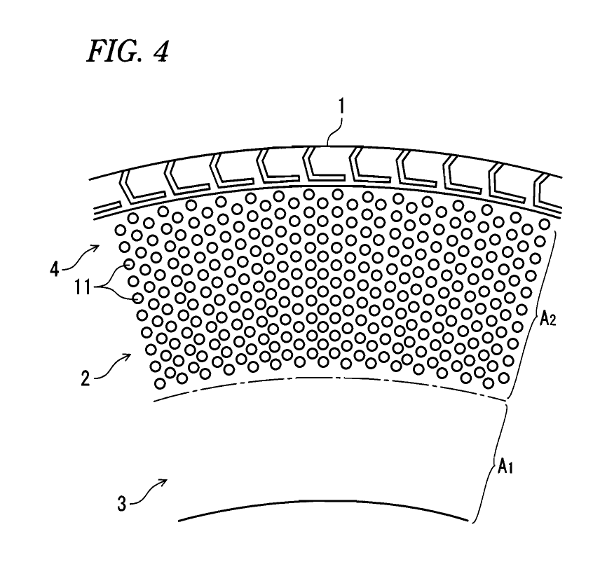

Hereinafter, a first embodiment of the present invention will be described with reference to FIG. 1 to FIG. 4. The pneumatic tire shown in these drawings includes a tread portion 1 formed on the tire outer peripheral surface side, a pair of side wall portions 2 formed on both sides in the tire width direction, a pair of bead portions 3 formed on both sides in the tire width direction, and buttress portions 4 formed between the tread portion 1 and the side wall portions 2.

This pneumatic tire is formed by an inner liner 5 disposed on the tire inner surface side, a carcass member 6 disposed on the outer side of the inner liner 5, a pair of bead members 7 disposed on both sides in the tire width direction, a belt 8 disposed on the outer side of the carcass member 6, a tread member 9 disposed on the tire outer peripheral surface side, and a pair of side wall members 10 disposed on both side surface sides of the tire.

The inner liner 5 is formed of a sheet-like rubber with low gas permeability as a main material, and disposed on the inner peripheral surface side of the carcass member 6.

The carcass member 6 is formed by covering a plurality of reinforcement cords 6a by a sheet-like rubber, and both end sides are folded back to the side wall portion 2 sides from the inner side to the outer side in the tire width direction so as to roll the bead members together.

The bead member 7 includes a bead core 7a formed by bundling wires such as metal wires, and a bead filler 7b formed of rubber having a substantially triangular sectional shape, and the bead filler 7b is disposed on the outer peripheral side of the bead core 7a.

The belt 8 is formed by covering a belt cord made of steel or high-strength fibers, etc., by a sheet-like rubber, and is disposed on the outer peripheral surface side of the carcass member 6.

The tread member 9 is made of rubber formed by extrusion molding, and disposed to cover the central side in the width direction of the carcass member 6 and the outer peripheral surface side of the belt 8, and on the outer peripheral surface of the tread member, grooves 1a forming a tread pattern are formed at the time of vulcanization molding.

The side wall members 10 are made of rubber formed by extrusion molding, and are disposed so as to cover both sides in the tire width direction of the carcass member 6.

On the outer side surface of the pneumatic tire, in predetermined second regions A2 (for example, the ranges not less than 35% and not more than 85% of the tire cross-section height H from the inner side end portions in the tire radial direction) except for first regions A1 within 35% of the tire cross-section height H from the inner side end portions in the tire radial direction, a large number of recesses 11 are provided in the tire circumferential direction and the tire radial direction. The tire cross-section height is a tire cross-section height in the state where a normal internal pressure regulated by JATMA standards, ETRTO standards, or TRA standards is filled in the tire, and a normal load regulated by the same standards is applied. The recesses 11 are formed into circular spherical shapes with a diameter not less than 0.5 mm and not more than 8 mm and a maximum depth not less than 0.3 mm and not more than 2 mm, and are formed into the same size and disposed at even intervals. In this case, the recesses 11 are formed so that the total area (the entire area of all recesses 11 on the tire surface) becomes not less than 10% and not more than 80%, more preferably, not less than 25% and not more than 65% of the second region A2. In addition, the recesses 11 do not include recesses of characters, symbols, or emblems indicated on the tire side surface.

The pneumatic tire is formed so that the outer diameter D and the total width SW in the state where the tire is fitted to a standard rim regulated by JATMA standards, ETRTO standards, or TRA standards and a normal internal pressure is applied fall within ranges not less than 0 mm and not more than 6 mm with respect to the lower limits of the standard dimensions. Here, the standard dimensions are dimensions of the outer diameter and the total width regulated by JATMA standards, ETRTO standards, or TRA standards. However, JATMA standards do not regulate the lower limit of the total width, so that the lower limit regulated by ETRTO standards is used as the lower limit of the total width.

Further, the pneumatic tire is formed so that the tread ground contact width TW at 60% load becomes not less than 60% and not more than 75% of the total width SW.

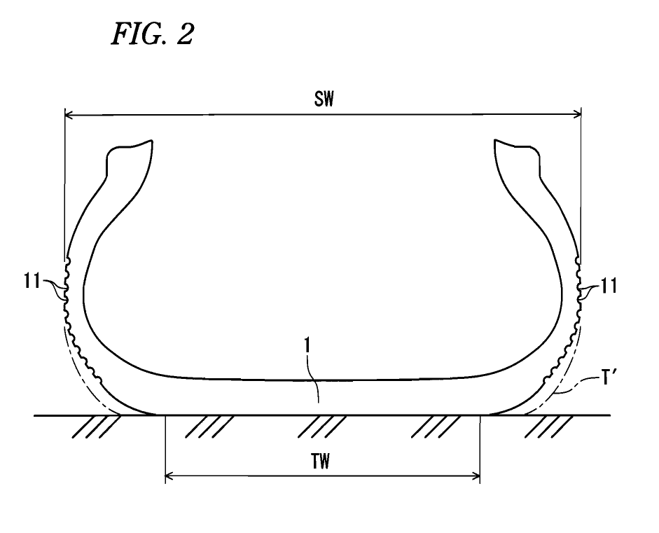

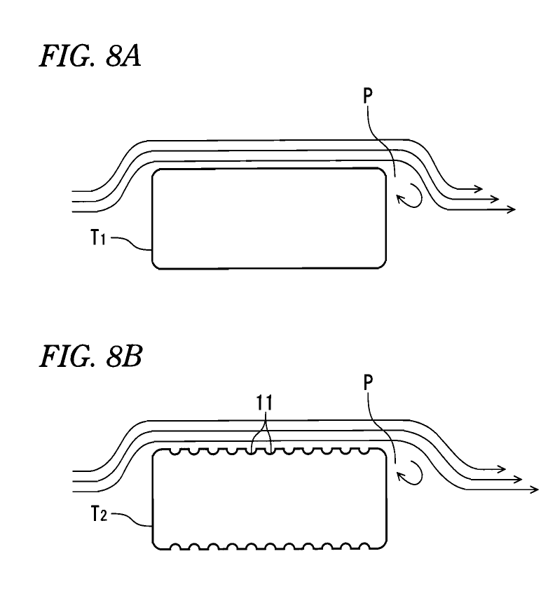

The pneumatic tire of the present embodiment is formed so that the outer diameter D and the total width SW fall within ranges not less than 0 mm and not more than 6 mm with respect to the lower limits of the standard dimensions, so that the outer diameter D and the total width SW are set to the minimum dimensions within ranges of the standard dimensions or close to the minimum dimensions, and the forward projection area becomes smaller than that of a tire having an outer diameter and a total width larger than the ranges. Further, the tire is formed so that the tread ground contact width TW becomes not less than 60% and not more than 75% of the total width SW, and therefore, the forward projection area becomes smaller than that of a tire T′ (alternate long and short dashed line of FIG. 2) having a tread ground contact width larger than the range. Further, turbulence is generated around the tire when the vehicle travels due to a large number of recesses 11 provided on the tire outer side surface, and as shown in FIG. 8A and FIG. 8B, a low-pressure portion P (region with a lower air density) brought about at the rear of the tire T1 having recesses 11 becomes smaller than that of a tire T2 having no recesses 11, and accordingly, the drag (force that pulls back the tire rearward) due to the low-pressure portion P for only that amount becomes smaller.

Thus, the pneumatic tire of the present invention is formed so that the outer diameter D and the total width SW fall within ranges not less than 0 mm and not more than 6 mm with respect to the lower limits of the standard dimensions and the tread ground contact width TW becomes not less than 60% and not more than 75% of the total width SW, so that the forward projection area can be made smaller, and the air resistance when traveling at a high speed can be effectively reduced. In particular, the ground contact surface side of the tire is not covered by the front surface of the vehicle, so that by reducing the tread ground contact width TW with respect to the total width SW, the forward projection area on the ground contact surface side can be made smaller as shown in FIG. 2, and this is very advantageous for reduction in air resistance.

By providing a large number of recesses 11 in the tire circumferential direction and the tire radial direction on the tire outer side surface, turbulence is generated in the air around the tire by the recesses 11, so that drag that pulls back the tire rearward can be made smaller, and the air resistance of the tire when traveling at a high recesses 11 are provided in the second regions A2 except for the first regions A1 within 35% of the tire cross-section height from the inner side end portions in the tire radial direction, so that the recesses 11 can be disposed on the outer side in the tire radial direction on which the revolution speed is relatively higher than on the inner side in the tire radial direction, so that the turbulence generating effect due to the recesses 11 can be increased, and a great separation phenomenon can be suppressed.

The recesses 11 are formed to have a depth not less than 0.3 mm and not more than 2 mm, so that it is prevented that the turbulence generating effect becomes insufficient due to an excessively small depth and air resistance increases due to an excessively large depth.

Further, the recesses 11 are formed into circular shapes with a diameter not less than 0.5 mm and not more than 8 mm, so that it is prevented that the turbulence generating effect becomes insufficient due to excessively small recesses 11 and air resistance increases due to excessively large recesses 11.

In the first embodiment, the recesses 11 formed into circular shapes are shown, however, they may be formed into other shapes such as oval or polygonal shapes. In this case, when they have oval shapes, the average of the longer axis and the shorter axis of the oval shape is set as the diameter of the recess, and in the case of polygonal shapes, the outer diameter of the circumscribed circle is set as the diameter of the recess so that the diameters become not less than 0.5 mm and not more than 8 mm.

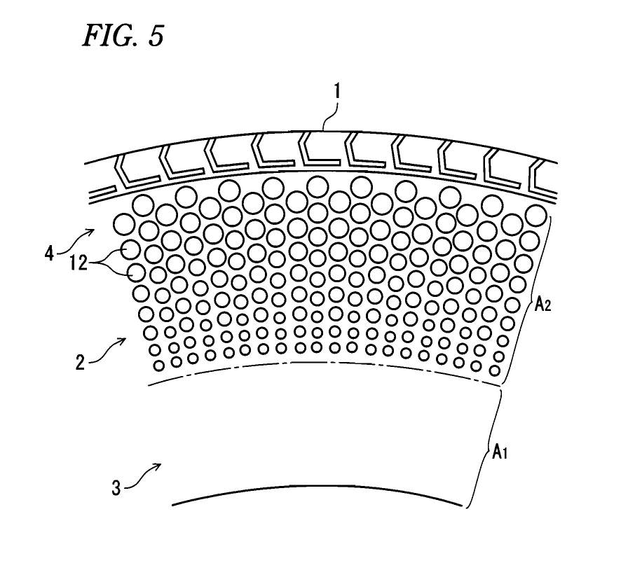

In the embodiment described above, the recesses having the same size are provided, however, the recesses may be formed so that the closer the position to the outer side in the tire radial direction, the larger the size like the recesses 12 shown in the second embodiment of FIG. 5. Specifically, by disposing larger recesses 12 on the outer side in the tire radial direction on which the revolution speed becomes relatively higher than on the inner side in the tire radial direction, the turbulence generating effect can be further increased and a great separation phenomenon can be further suppressed, so that this is very advantageous for reduction in air resistance.

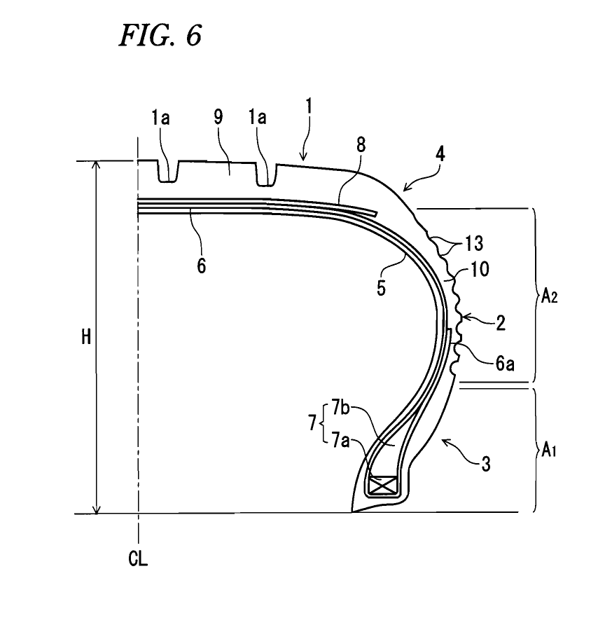

Further, in the first embodiment described above, recesses 11 having the same depth are provided, however, the recesses may be formed so that the closer the position to the outer side in the tire radial direction, the smaller the depth like the recesses 13 shown in the third embodiment of FIG. 6. Specifically, by disposing recesses 13 with smaller depths on the outer side in the tire radial direction on which the revolution speed becomes relatively higher than on the inner side in the tire radial direction, the turbulence generating effect can be further increased and a great separation phenomenon can be further suppressed, so that this is very advantageous for reduction in air resistance.

A sufficient effect can be obtained only on the outer side in the width direction of the vehicle on which air resistance becomes higher when the tire is fitted to the vehicle, so that the recesses 11 (12, 13) may be provided only on one side surface in the tire width direction which becomes the outer side in the width direction of the vehicle when the tire is fitted to the vehicle. Accordingly, the cost of the mold according to formation of the recesses 11 (12, 13) can be reduced.

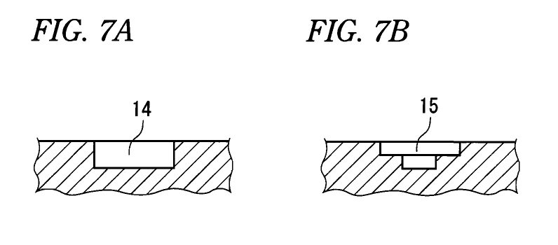

In the embodiment described above, recesses formed to be spherical are shown, however, they may be formed to have a quadrilateral sectional shape like the recess 14 shown in FIG. 7A, or may be formed two-tiered including quadrilateral sectional shapes different in size like the recess 15 shown in FIG. 7B.

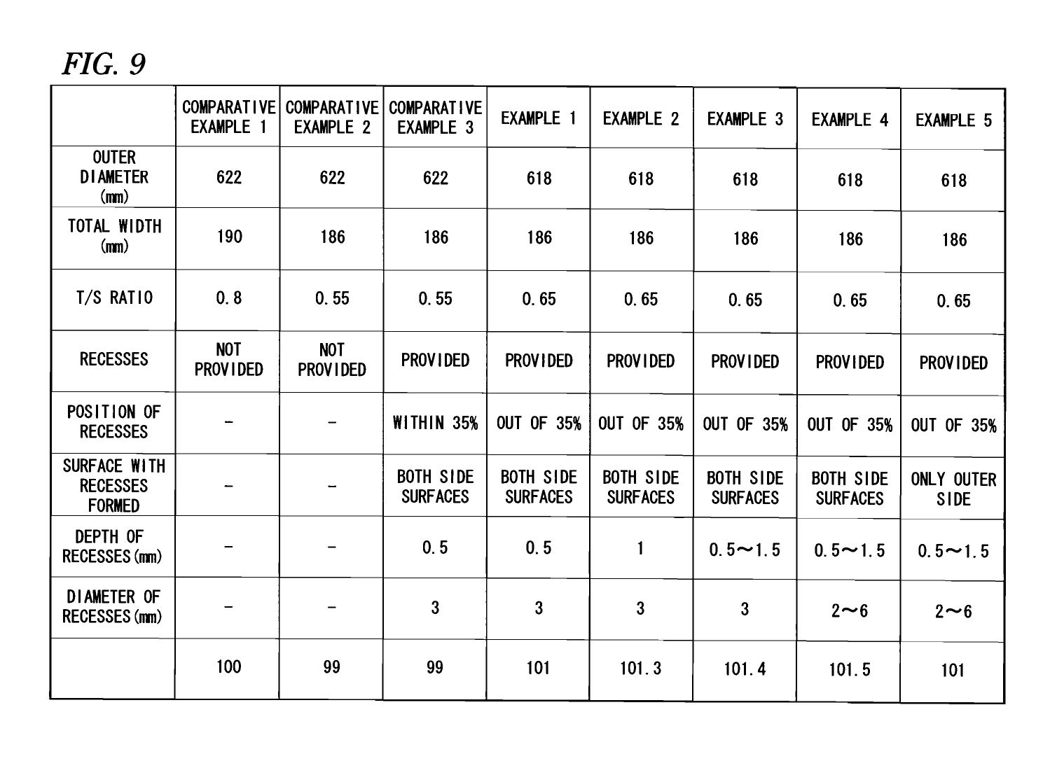

Here, a fuel efficiency test was conducted for Examples 1 to 5 of the present invention and Comparative examples 1 to 3, and the results shown in FIG. 9 were obtained. In this test, tires with outer diameters more than 6 mm larger than the lower limit of the standard dimension were used in Comparative examples 1 to 3, and tires with outer diameters not more than 6 mm larger than the lower limit of the standard dimension were used in Examples 1 to 5. Further, in Comparative example 1, a tire with a total width more than 6 mm larger than the lower limit of the standard dimension was used, and tires with total widths not more than 6 mm larger than the lower limit of the standard dimension were used in Comparative examples and 3 and Examples 1 to 5. Further, in Comparative example 1, a tire having a value (T/S ratio) more than 0.7 obtained by dividing a tread ground contact width at 60% load by a total width when a normal inner pressure is applied and the tire is fitted to a standard rim was used, and in Comparative examples 2 and 3, tires with T/S ratios less than 0.65 were used, and in Examples 1 to 5, tires with T/S ratios not less than 0.65 and not more than 0.7 were used. Tires without recesses were used in Comparative examples 1 and 2, and tires with circular recesses were used in Comparative example 3 and Examples 1 to 5. In this case, in Comparative example 3, a tire with recesses provided in ranges within 35% of the tire cross-section height from the inner side end portions in the tire radial direction was used, and in Examples 1 to 5, tires with recesses provided in regions except for ranges within 35% of the tire cross-section height from the inner side end portions in the tire radial direction were used. Further, in Comparative example 3 and Examples 1 to 4, a tire with recesses provided on both side surfaces in the tire width direction was used, and in Example 5, a tire with recesses provided only on one side surface in the tire width direction which becomes the outer side in the width direction of a vehicle when the tire is fitted to a vehicle was used. In Examples 3 to 5, tires with recesses, the depths of which become smaller as their positions become closer to the outer side in the tire radial direction were used, and in Examples 4 and 5, tires with recesses, the sizes of which become larger as their positions become closer to the outer side in the tire radial direction were used.

In this test, a tire size of 185/65R15 was used, however, in the case of this size, according to JATMA standards, the standard outer diameter is 614 mm to 628 mm and the standard total width (ETRTO standards were applied to the lower limit) is 182 mm to 197 mm, and according to ETRTO standards, the standard outer diameter is 614 mm to 628 mm and the standard total width is 182 mm to 196 mm, and according to TRA standards, the standard outer diameter is 614 mm to 628 mm and the standard total width is 182 mm to 194 mm.

In this test, a tire with an air pressure of 230 kPa was fitted to a (motor-assisted) small passenger car (front-wheel drive) of 1500 cc displacement, and fuel consumption when the car travels ten laps of a 2 km long test course at a speed of 100 km/h was measured and indexed, and Comparative examples 2 and 3 and Examples 1 to 5 were evaluated by defining Comparative example 1 as 100. In this case, the larger the index, the higher the superiority. As a result of the test, Examples 1 to 5 are superior to Comparative examples 1 to 3 in fuel efficiency.

As described in the above, there is provided a pneumatic tire having smaller forward projection area. Accordingly, the drag that pulls back a tire rearward when traveling can be made smaller, so that air resistance at the time of high-speed traveling can be effectively reduced, and this is very advantageous in terms of improvement in fuel efficiency.

Although the embodiments according to the present invention have been described above, the present invention may not be limited to the above-mentioned embodiments but can be variously modified. Components disclosed in the aforementioned embodiments may be combined suitably to form various modifications. For example, some of all components disclosed in the embodiments may be removed or may be appropriately combined.

Additional advantages and modifications will readily occur to those skilled in the art. Therefore, the invention in its broader aspects may not be limited to the specific details and representative embodiments shown and described herein. Accordingly, various modifications may be made without departing from the spirit or scope of the general inventive concept as defined by the appended claims and their equivalents.

What is claimed is:

1. A pneumatic tire comprising:
an outer diameter and a total width being set to fall within ranges from 0 mm to 6 mm with respect to lower limits of standard dimensions in a state where the pneumatic tire is fitted to a standard rim and a normal internal pressure is applied;
a tread ground contact width at 60% load being set to fall within a range from 60% to 75% of the total width; and
a plurality of recesses being provided over a tire circumferential direction and a tire radial direction in a region defined on a tire outer surface excluding an area extending from an inner side end portion of the pneumatic tire to a position within 35% height of a tire cross-section height.

2. The pneumatic tire according to claim 1,
wherein the recesses are formed to have a depth in a range from 0.3 mm to 2 mm.

3. The pneumatic tire according to claim 1,
wherein the recesses are formed to have a diameter in a range from 0.5 mm to 8 mm.

4. The pneumatic tire according to claim 1,
wherein the recesses are formed to have larger size for those positioned more toward an outer side of the pneumatic tire in the tire radial direction.

5. The pneumatic tire according to claim 1,
wherein the recesses are formed to have smaller depth for those positioned more toward an outer side of the pneumatic tire in the tire radial direction.

6. The pneumatic tire according to claim 1,
wherein the recesses are exclusively provided on one side surface of the pneumatic tire in the tire width direction, which becomes an outer side in a width direction of a vehicle when the pneumatic tire is fitted to the vehicle.
